(19) United States
(12) Patent Application Publication
(10) Pub. No.: US 2002/0197075 A1
(43) Pub. Date: Dec. 26, 2002

(54) Eyepiece to instrument coupler

(76) Inventor: Richard L. Crockett, San Marcos, CA (US)

Correspondence Address: Richard L. Crockett, 29325 Hwy. 178, Onyx, CA, 93255, US

(21) Appl. No.: 10/024,732

(22) Filed: Dec. 19, 2001

Related U.S. Application Data
(60) Provisional application No. 60/256,394, filed on Dec. 19, 2000.

(51) Int. Cl. G03B 17/48

(52) U.S. Cl. 396/429

(57) ABSTRACT

Invention presented is a mechanical coupler complete in its actualization to convey an optical image from a collector device to an image recording device. In Typical fashion this would be an image collected by an optical scope of some form and conveyed to film or imaging sensor. More specifically, Invention will attach to an image collecting device such as but not limited to a telescope or microscope by clamping onto the eyepiece and supporting in optical alignment, the body of a camera attached by means of the tripod socket screw. Specifically a person with a digital camera having a fixed lens and as common, a lens without a filter ring, can attach said camera to a telescope, microscope or binoculars without any other adapters or specialized fittings.

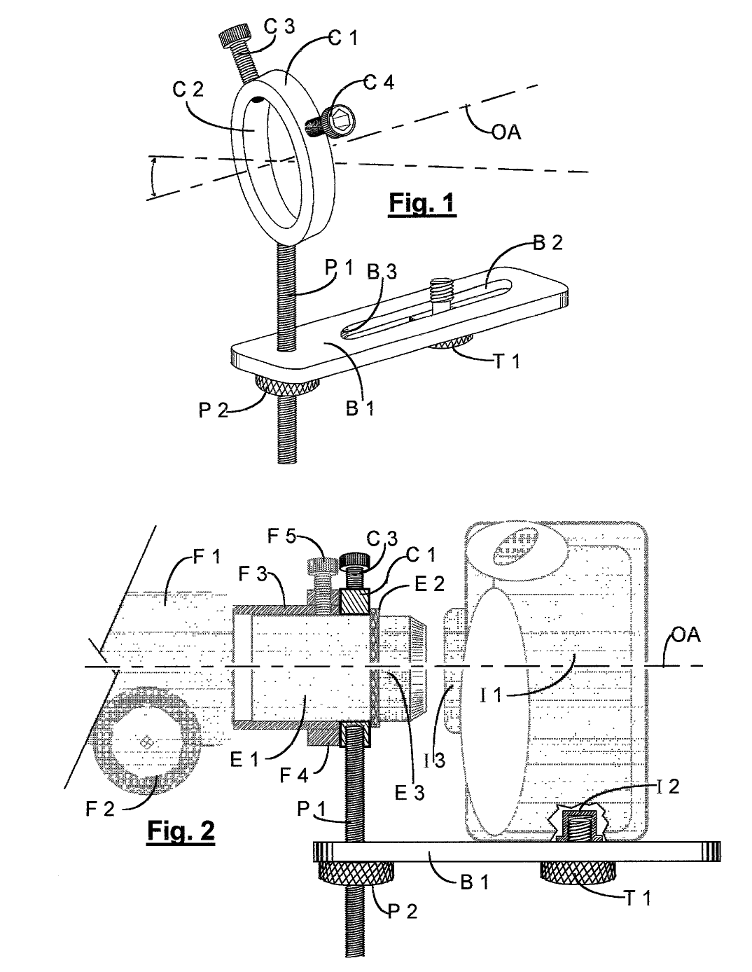

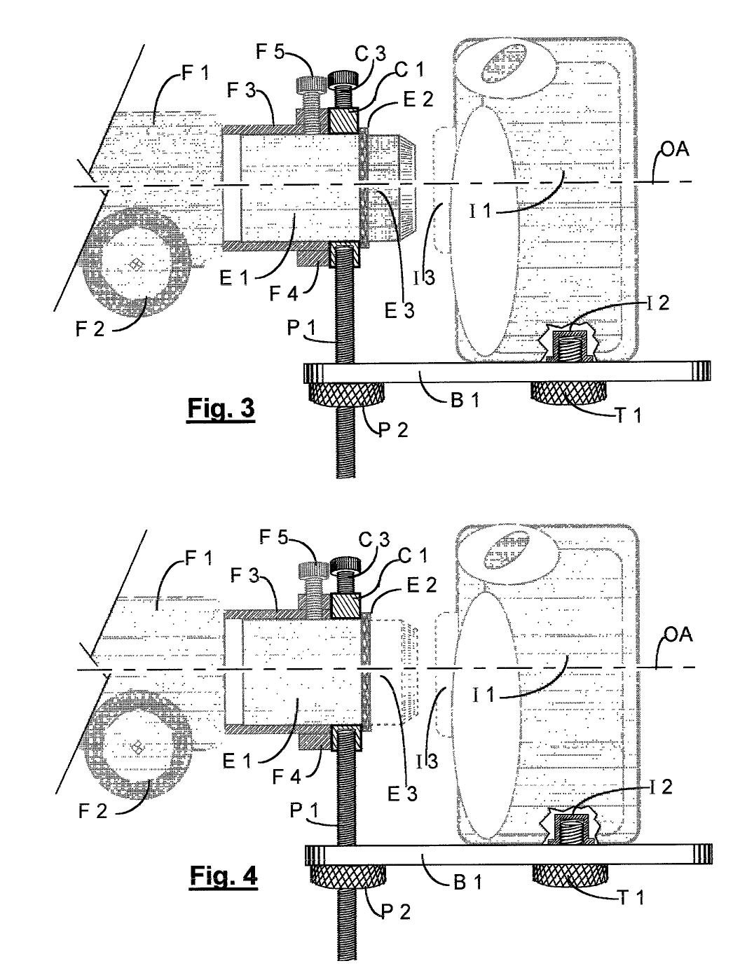

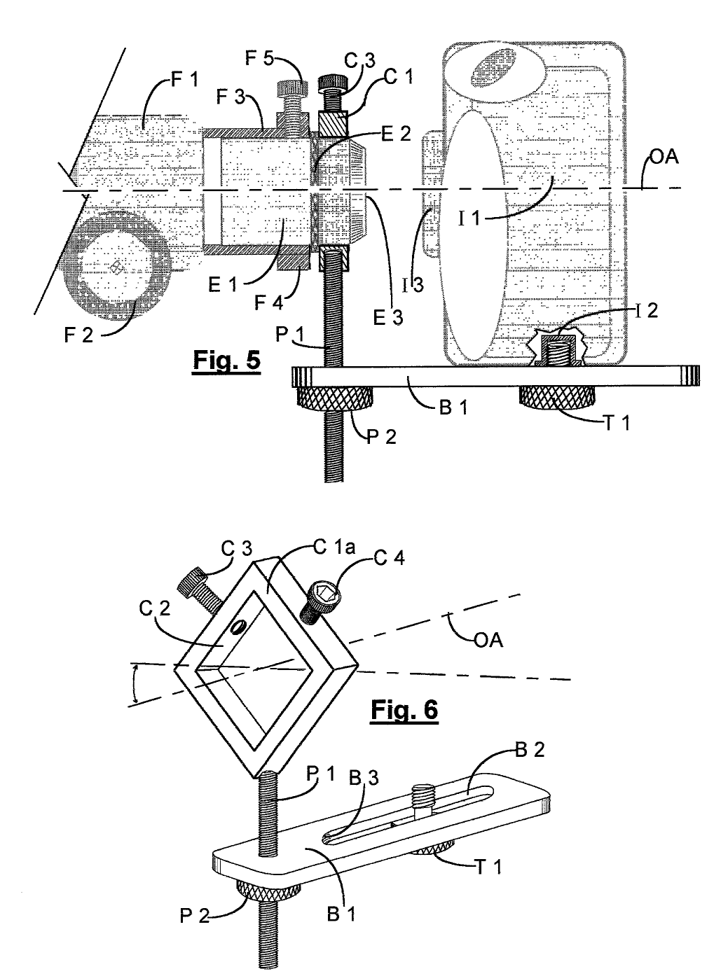

### BACKGROUND OF THE INVENTION

1. Field of the Invention

You have a telescope and then buy an inexpensive modern miracle called a digital camera. Now you would like to keep a record of what you see in the telescope but the fixed lens on that new camera does not give nearly enough magnification. There is a common inclination to push the lens of the camera up to the eyepiece of the telescope. The image shakes and blurs because you cannot hold the camera still nor in perfect optical alignment. Your camera is not one of those real expensive ones and the non-removable lens also has no filter thread and most don't so you cannot connect the lens to the telescope. Ideally you need a coupler that will allow you to securely connect and hold your camera in optical alignment with the eyepiece of the telescope. This invention is intended to completely answers those requirements without any other adapters or specialized fittings.

2. Description of the Prior Art

There has long been a need for an adapter that can couple a viewing instrument to a camera or other form of recording instrument. Flexibility meant lower cost and less instrumentation which in turn meant less equipment to carry into the field. Hopefully it was more economical on the bank account as well.

An adapter was patented by Beecher (U.S. Pat. No. 2,765,718) in 1956 that would couple a camera to a binocular. Utility of that adapter differs from mine in that the camera lens was removed as well as the eyepiece shroud and rubber lens cap and the adapter used was machined to fit the precise threads exposed from the removal of the shroud. If the threads were a different size or pitch, the adapter would not work, mine does. If the camera lens were not removable the adapter would not work, mine does. My invention will also work on other forms of scopes and eyepiece that have fixed shrouds and rubber eyecups were as this adapter will not.

As early as the 1960s there have been body to body mounts for telescopes and there are still some around today but their utility is both different and limited. The body to body mount attaches to the telescope usually in a semi-permanent way and then holds a camera over the eyepiece of the scope. It is not interchangeable with other types of scopes and often with other sizes of scopes, my invention does. Because of longer coupling lengths these body to body mounts tend to be wobbly and cannot move with the eyepiece into focus but must be positioned separately. My invention being short coupled is very steady and by attaching to the eyepiece, is focused in a single action with said eyepiece.

An adapter was patented by Feinbloom (U.S. Pat. No. 4,143,938) in 1979 that would couple a camera to a microscope. Utility of that adapter differs from mine in that the adapter is so specialized that it will work only with a microscope with specific modifications. In a heavy duty industrial sort of way that would be better but my invention will allow virtually any camera to adapt to virtually any scope without modification to that scope. With my invention the scope and camera can be separated and each used for other purposes.

An adapter was patented by Tawara, a Japanese Inventor, (U.S. Pat. No. 4,318,395) in 1982, with a prior Japan patent (54-69289), that would couple a camera to an endoscope. Utility of that adapter differs from mine in that the adapter is specifically designed for an endoscope ocular or eyepiece and requires the unique conical shaped barrel of such eyepiece to clamp onto. There is also no provision for a wide range of cameras with and without removable lenses and filter rings. My invention resolves all these issues and will work on other scopes as well.

Patents (U.S. Pat. No. 4,723,864), (U.S. Pat. No. 4,740,058), (U.S. Pat. No. 4,807,594), (U.S. Pat. No. 4,844,071) each dwell on the unique shape of the endoscope ocular and again vary from and lack the universal nature and utility of my Invention.

An adapter was patented by Centkowski, Manios and Weaver (U.S. Pat. No. 4,862,199) in 1989 that would couple a camera to a borescope. Utility of that adapter differs from mine in that it requires the removal of both the eyepiece and camera lens. If either the camera lens or the eyepiece cannot be removed their adapter will not work but mine will.

An adapter was patented by Benz (U.S. Pat. No. 5,053,794) in 1991 that claims to be a “Universal Adapter.” In the form presented, the adapter will not connect to any camera and to do so actually requires special and specific adapters. What the adapter actually is is a version of ring clamp that will only clamp on to the outside of an eyepiece head. If the eyepiece head is not wide enough, has a projecting flange, has a rubber eye cup or is tapered, this adapter will not work but my invention will work in each and all cases. Utility of that adapter also differs in that it will not clamp onto the lower barrel of the eyepiece below the head so in the case of the aforementioned eyepieces, the adapter cannot be used at all but my coupler will. The adapter will not fit onto square shrouds such as but not limited to an Otto-scope but my invention will. Furthermore the adapter does not address the connection to a camera that does not have a removable lens or a lens with filter ring threads but my Invention does.

Most recently and a long time after my initial filing I saw an adapter on E-Bay. That adapter used a insert that replaces the eyepiece in the focuser and then the eyepiece is replaced into the top end of the insert. From the insert is a slip post and base bracket. The utility of this adapter differs from mine in that it displaces the eyepiece from focus by more than the barrel length of the eyepiece which is often too much. In many cases the scope cannot come to focus. A slip post does not allow one to move the camera aside and return it with any degree of accuracy. My coupler can be precisely repositioned. The adapter also will not work with binoculars or other scopes with non-removable eyepieces, my invention does.

### SUMMARY OF THE INVENTION

In simple terms, this invention was designed to readily couple a scope of any form to a camera of any form. This Invention is designed to attach to the eyepiece or eyepiece shroud of any generic telescope, microscope, binocular. spotting scope, endoscope, borescope etc. with or without removeable eyepieces and couple said scope to a camera or other imaging device with or without removeable lenses, and with fixed, non-removable lenses that also do not have threads for filter rings. It is by design that the Invention can be used on more than one type or size scope with more than one type or size camera without additional adapters.

I claim and therefore seek protection secured by Letters of Patent for the following:

1. A mechanical Coupler able to make and hold an optical connection between some form of viewing device such as but not limited to Telescopes, Binoculars, Microscopes, Otto-Scopes etc., to a Camera or some other form, of image recording device. Said coupler consists of:
(a) a clamping component or mechanism that enables said Coupler to attach to the eyepiece of a scope or other viewing device.
(b) an adjustable post that supports and fixes the clamping component to a slotted base bracket.
(c) a base bracket with provision for attachment to the clamp supporting post and cut with a slot running perpendicular to and from the post. Through this slot is inserted a tripod socket screw able to slide laterally up and down the base bracket and to or from the post.
(d) a tripod socket screw with an undercut on the threads so that it may engage the slot in the base bracket, thread through the bracket and then become free to slide up and down the length of the slot. Once threaded through the base bracket to the under cut area of the threaded, the tripod socket screw becomes free to engage, position and attach an Image recording instrument such as a digital camera, etc.
(e) a jam nut or similar to secure position between adjustable post and base bracket.

2. An eyepiece to instrument Coupler according to claim 1, that is complete, requiring no other adapter or attachment, to couple a viewing device to an image recording device or instrument. Said Coupler accomplishes this task by clamping onto eyepiece with a clamping mechanisms roughly sized and shaped for that purpose and with the ability to be adjusted to fit. Said clamping component is in turn supported by an adjustable post and base bracket able to allow optical alignment with image recording instrument attached to said base bracket by means of a tripod socket screw.

3. An eyepiece to instrument Coupler according to claim 1, that has a clamping mechanism that is roughly sized and shaped to allow the barrel of an eyepiece to slip into, extend through, and shoulder up to the clamping mechanism's face. Once secured by adjustment, remaining portion of eyepiece is inserted into focuser with alternate face of clamping mechanism shouldered up against exterior face of focuser.

4. An eyepiece to instrument Coupler according to claim 1, that has a clamping mechanism that is roughly sized and shaped to allow clamping onto the eyepiece head or over the shroud of non-removable eyepieces such as but not limited to Otto-scopes.

5. An eyepiece to instrument Coupler according to claim 1, that has an adjustable post attached to the clamping mechanism and allows said clamp to be positioned up and down from a base bracket and independently rotate about the axis of said post.

6. That the afore mentioned post in claim 5, can be positioned and hold afore mentioned clamp and base bracket apart at any selectable distance by means of threads or stops and in such a way that distance and orientation is independently repeatable and adjustable, allowing for the moving of camera or instrument to the side and then returned without need for realignment.

7. An eyepiece to instrument Coupler according to claim 1, that has a base bracket that accommodates afore mentioned vertical post that threads through said base bracket affecting both the attachment and positioning of aforementioned clamp to base bracket. Said Base bracket also has slot for a tripod socket screw that engages, slides and rotates into position and affixes a camera type instrument to the base bracket. Said base bracket allowing flexibility in positioning of all attachments, provides for accurate, repeatable optical alignment between eyepiece and image recording instrument.
